(19) United States
(12) Patent Application Publication
(10) Pub. No.: US 2026/0178889 A1
(43) Pub. Date: Jun. 25, 2026

(54) METHOD, DEVICE AND STORAGE MEDIUM FOR INTERACTION PROCESSING

(71) Applicant: Beijing Zitiao Network Technology Co., Ltd., Beijing (CN)

(72) Inventors: Xujie TAO, Beijing (CN); Jia GUO, Beijing (CN); Mengqian LIU, Beijing (CN); Jie LIN, Beijing (CN); Shuo LIU, Beijing (CN); Chi FANG, Beijing (CN)

(21) Appl. No.: 19/349,929

(22) Filed: Oct. 3, 2025

(30) Foreign Application Priority Data
Dec. 20, 2024 (CN) 202411900036.5

(51) Int. Cl. G06N 3/0475; G06N 3/045

(52) U.S. Cl. CPC G06N 3/0475; G06N 3/045

(57) ABSTRACT

The disclosure provides a method, a device and a storage medium for interaction processing. A method includes: generating, based on context information related to an interaction, task description information for an interaction task with a trained first machine learning model, the task description information at least indicating whether the interaction task is to be performed; generating, in response to the task description information indicating that the interaction task is to be performed, a control instruction for at least one component of a terminal device based on the task description information by using a predetermined association relationship between task description information and control instructions; and controlling, based on the control instruction, the at least one component of the terminal device to perform the interaction task.

### CROSS-REFERENCE

This application claims the benefit of Chinese Patent Application No. 202411900036.5, filed on Dec. 10, 2024, entitled “METHOD, APPARATUS, DEVICE, STORAGE MEDIUM, AND PROGRAM PRODUCT FOR INTERACTION PROCESSING”, the entirety of which is incorporated herein by reference.

### FIELD

Example embodiments of the present disclosure generally relate to the field of computers, and in particular, to a method, an electronic device and a computer-readable storage medium for interaction processing.

### BACKGROUND

With the development of information technologies, various terminal devices may provide various services to people in terms of work and life. For example, an application providing a service may be deployed in a terminal device. The terminal device or the application may provide a task processing function to the user, to assist the user in using the terminal device or the application. The terminal device may receive a task request for the task, execute the task request to determine an execution result of the task, and provide the execution result to the user.

### SUMMARY

In a first aspect of the present disclosure, a method for interaction processing is provided. The method includes: generating, based on context information related to an interaction, task description information for an interaction task with a trained first machine learning model, the task description information at least indicating whether the interaction task is to be performed; generating, in response to the task description information indicating that the interaction task is to be performed, a control instruction for at least one component of a terminal device based on the task description information by using a predetermined association relationship between task description information and control instructions; and controlling, based on the control instruction, the at least one component of the terminal device to perform the interaction task.

In a second aspect of the present disclosure, an apparatus for interaction processing is provided. The apparatus includes: a description information generation module configured to generate, based on context information related to an interaction, task description information for an interaction task with a trained first machine learning model, the task description information at least indicating whether the interaction task is to be performed; a control instruction generation module configured to generate, in response to the task description information indicating that the interaction task is to be performed, a control instruction for at least one component of a terminal device based on the task description information by using a predetermined association relationship between task description information and control instructions; and an interaction task execution module configured to control, based on the control instruction, the at least one component of the terminal device to perform the interaction task.

In a third aspect of the present disclosure, an electronic device is provided. The device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The medium stores a computer program thereon. The computer program, when executed by the processor, implements the method of the first aspect.

In a fifth aspect of the present disclosure, a computer program product is provided. The product includes a computer program, where the computer program, when executed by a processor, implements the method according to the first aspect of the present disclosure.

It should be understood that the content described in this Summary section is not intended to limit the key features or critical features of the embodiments of the present disclosure, nor is it intended to limit the scope of the present disclosure. Other features of the present disclosure will be readily understood from the following description.

### BRIEF DESCRIPTION OF DRAWINGS

The above and other features, advantages, and aspects of various embodiments of the present disclosure will become more apparent from the following detailed description taken in connection with the accompanying drawings. In the drawings, the same or similar reference signs refer to the same or similar elements, where:

FIG. 1 illustrates a schematic diagram of an example environment in which embodiments of the present disclosure can be implemented;

FIG. 2 illustrates an example of a conventional interaction process;

FIG. 3 illustrates an example architecture for interaction processing according to some embodiments of the present disclosure;

FIG. 4 shows a flowchart of a method for interaction processing according to some embodiments of the present disclosure;

FIG. 5 illustrates an example structural block diagram of an apparatus for interaction processing according to some embodiments of the present disclosure; and

FIG. 6 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

In the description of the embodiments of the present disclosure, the terms “comprising/including” and its equivalents should be construed as being open-ended inclusive, i.e., “including, but not limited to”. The term “based on” should be construed as “based at least in part on”. The terms “one embodiment” or “the embodiment” should be construed as “at least one embodiment”. The term “some embodiments” should be understood as “at least some embodiments”. Other definitions, either explicit or implicit, may also be included below.

Herein, unless explicitly stated, performing one step “in responding to A” does not imply that this step is performed immediately after “A”, but one or more intermediate steps may be included.

It should be understood that the data involved in the technical solution (including but not limited to the data itself, the acquisition or use of the data) should comply with the requirements of the corresponding laws and regulations and related provisions.

It should be understood that before using the technical solutions disclosed in the implementations of the present disclosure, the user should be informed of the types, use ranges, use scenarios, and the like of the personal information related to the present disclosure in an appropriate manner according to relevant laws and regulations and acquire the user's authorization.

For example, in response to receiving an active request from a user, prompt information is sent to the user to explicitly prompt the user that the requested operations to be performed would require acquisition and use of personal information of the user. Thus, the user can autonomously select whether to provide personal information to software or hardware such as an electronic device, an application, a server, or a storage medium that performs the operations of the technical solution of the present disclosure, according to the prompt information.

As an optional but non-limiting implementation, in response to receiving an active request from a user, the prompt information may be sent to the user, for example, in the form of a pop-up window in which the prompt information is presented in the form of text. In addition, the pop-up window may further carry a selection control for the user to select “agree” or “disagree” to provide personal information to the electronic device.

It should be understood that the above process for notifying and acquiring user authorization is merely illustrative, and does not limit the implementations of the present disclosure, and other manners that satisfy related laws and regulations may also be applied to the implementations of the present disclosure.

As used herein, the term “model” may learn an association relationship between respective inputs and respective outputs from training data. Therefore, a corresponding output may be generated for a given input after training is complete. The generation of the model may be based on machine learning techniques. Deep Learning is a machine learning algorithm that processes inputs and provides corresponding outputs by using a multi-layer processor. The neural network model is one example of a deep learning-based model. As used herein, a “model” may also be referred to as a “machine learning model,” a “learning model,” a “machine learning network,” or a “learning network”. These terms can be used interchangeably herein.

A “neural network” is a deep learning based machine learning network. The neural network is capable of processing inputs and providing corresponding outputs, which typically include an input layer and an output layer and one or more hidden layers between the input layer and the output layer. Neural networks used in deep learning applications typically include many hidden layers, increasing the depth of the network. Each layer of the neural network is connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), and each node processing input from the previous layer.

Generally, machine learning may generally include three stages, a training stage, a testing stage, and an application stage (also referred to as an inference stage). At the training stage, a given model may be trained using a large amount of training data, and constantly updating the parameter values, until the model is able to obtain consistent inferences that satisfy the expected objectives from the training data. Through training, the model may be considered to be able to learn an association between an input and an output (also referred to as a mapping from input to output) from the training data. The parameter values of the trained model are determined. In the testing stage, the test input is applied to the trained model to test whether the model can provide the correct output, thereby determining the performance of the model. The testing stage may sometimes be fused in a training stage. In the application or inference stage, the trained model may be used to process the actual model input based on the parameter value obtained by training, to determine a corresponding model output.

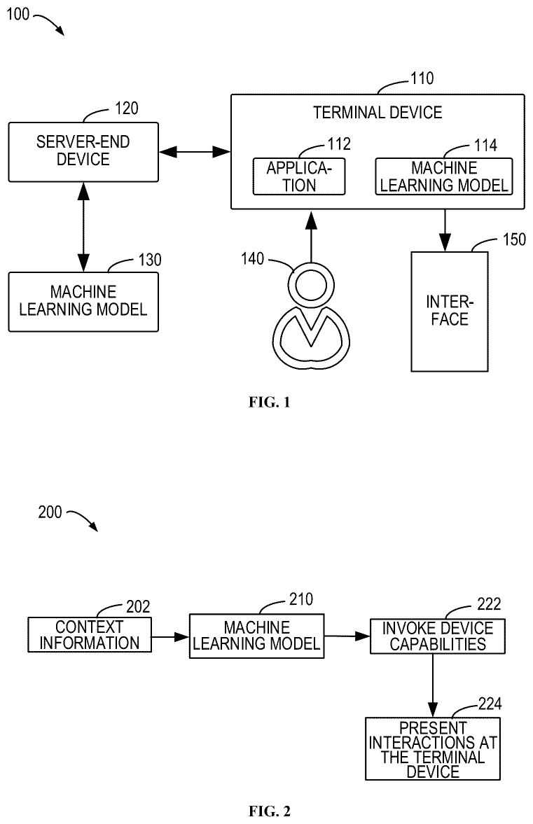

FIG. 1 illustrates a schematic diagram of an example environment 100 in which embodiments of the present disclosure can be implemented. In this example environment 100, an application 112 is installed in a terminal device 110. A user 140 may interact with the application 112 via the terminal device 110 and/or an attachment device of the terminal device 110. For example, the application 112 may collect voices of the user 140 via a voice collection component (for example, a microphone) of the terminal device 110, and may collect images or videos of the user 140 via an image collection component (for example, a camera) of the terminal device 110, and the like.

In an embodiment of the present disclosure, the application 112 may be any suitable application having a task processing function. For example, the application 112 may be a social interaction type application, a chat type application, a media item type application, or the like. The application 112 may, for example, provide a digital assistant for human-machine diag. The digital assistant supports text dialog services, voice dialog services, and content dialog under other modalities with the user 140. In some embodiments, the application 112 or digital assistant therein may utilize a machine learning model. For example, application 112 or a digital assistant therein may provide a question and answer service to user 140 with a machine learning model. The digital assistant's reply to the user may be determined based on a model output of the machine learning model.

The machine learning model may be a machine learning model (for example, a machine learning model 114) deployed locally at the terminal device 110, or may be a machine learning model (for example, a machine learning model 130 at a server 120) deployed at other devices. The machine learning model 114 and the machine learning model 130 may both be based on any suitable model structure, including but not limited to a Transformer model, a convolutional neural network (CNN), a recurrent neural network (RNN), a deep neural network (DNN), or the like. In some embodiments, the machine learning model 114 and/or the machine learning model 130 may be based on a language model (LM). The language model can have question and answering capability by learning from a large amount of corpora.

In some embodiments, the language model based machine learning model can receive model inputs of a text modality (e.g., a natural language and/or a machine language) and/or model inputs of non-text modalities (e.g., images, voice, video, etc.), and can generate the desired output based on the model inputs and a prompt. The prompt word herein is used to guide the machine learning model to generate a model output capable of solving the user demand indicated by the model input. In an application scenario for supporting a dialog with a user, the input of the user 140 may be provided to the machine learning model 114 and/or the machine learning model 130 as at least a part of the model input (other parts may include a prompt).

It should be noted that both the machine learning model 114 and the machine learning model 130 may include one or more machine learning models. If multiple machine learning models are included, the functions, structures, uses and the like of the multiple machine learning models may be the same or different.

In environment 100, if terminal device application 112 is active, terminal device 110 may present a user interface (e.g., interface 150) of application 112. Interface 150 may include various interfaces that can be provided by the application 112, such as a dialog interface between the user and the digital assistant (where a current dialog and a historical dialog may be presented, including text dialog content), and so forth. In some embodiments, the terminal device 110 may play the speech via the interface 150, and the speech may include a question speech from the user and a reply speech for the question speech.

In some embodiments, terminal device 110 communicates with server 120 to enable provisioning of services to application 112. For example, the server 120 may invoke the machine learning model 130 to support a human-machine dialog function between the application 112 and the user 140 based on the output of the machine learning model 130.

The electronic device 110 may be any type of mobile terminals, fixed terminals, or portable terminals, including a mobile phone, a desktop computer, a laptop computer, a notebook computer, a netbook computer, a tablet computer, a media computer, a multimedia tablet, PCS device, a personal navigation device, a Personal Digital Assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.).

The server 120 may be an independent physical server, may also be a server cluster or a distributed system formed by a plurality of physical servers, and it may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 120 may include, for example, a computing system/server, such as a mainframe, an edge computing node, a computing device in a cloud environment, etc. The server 120 may be implemented, for example, based on cloud environment.

It should be understood that the structures and functions of the various elements in environment 100 are described for illustrative purposes only and do not imply any limitation to the scope of the present disclosure.

As mentioned above, the terminal device may receive a task request for a task, and execute a task request to determine an execution result of the task, and provide the execution result to the user. The terminal device may perform the task with a machine learning model. Referring to FIG. 2, FIG. 2 illustrates an example 200 of model-based interaction processing in the related art.

As shown in example 200, in the related art, context information 202 of an interaction may be provided to a machine learning model 210. The context information 202 may include, for example, information collected by various sensing devices in the terminal device. The machine learning model 210 is typically a language model (LM) or a large language model (LLM). The model size of the machine learning model 210 is usually large, and the machine learning model 210 is usually deployed at the cloud. The machine learning model 210 may determine the manner of the interaction (e.g., whether to proactively present the interaction), the form of the interaction (e.g., voice form, text form, etc.), the timing of the interaction (i.e., when to interact), etc. based on the context information 202. The machine learning model 210 may proactively present (224) interactions at the terminal device (such as presenting text or playing speech at the terminal device) by invoking (222) related device capabilities.

Generally, the interaction can only present text or voice, which leads to a relatively single interaction form, affecting the interaction experience of the user. Because different terminal devices may include different components, the same terminal device may be installed with different systems or installed with different versions of components. Therefore, if a system, a model number, or a component version of the terminal device changes, to ensure accuracy of the interaction invocation policy, the machine learning model 210 needs to be retrained for the changed terminal device. Because the size of the machine learning model 210 is relatively large, the training process is complex, and a large amount of time is required for each training, frequent updating may result in excessively high model training efficiency and training cost.

According to an embodiment of the present disclosure, an improved solution for interaction processing is provided. According to the solution of the embodiments of the present disclosure, task description information for an interaction task is generated with a trained first machine learning model based on context information related to an interaction, the task description information at least indicating whether the interaction task is to be performed. In response to the task description information indicating that the interaction task is to be performed, a control instruction for at least one component of a terminal device is generated by using a predetermined association relationship between task description information and control instructions based on the task description information. The at least one component of the terminal device is controlled to perform the interaction task based on the control instruction.

In this way, control instructions for a specific device or component do not need to be directly generated by means of the machine learning model directly, but the generation of control instructions is realized through a two-stage generation solution. In the first stage, task description information is generated with a machine learning model. The task description information describes what task to perform. In the second stage, the task description information is mapped to the control instruction on the specific terminal device based on a predetermined strategy or another machine learning model. As such, for a machine learning model that relies on context information to determine an interaction task, the model need not be updated frequently, while a lighter policy or a model used in the second stage may be flexibly updated as needed to ensure flexibility and adaptability of the generated control instructions.

Some example embodiments of the present disclosure will be described below with continued reference to the accompanying drawings.

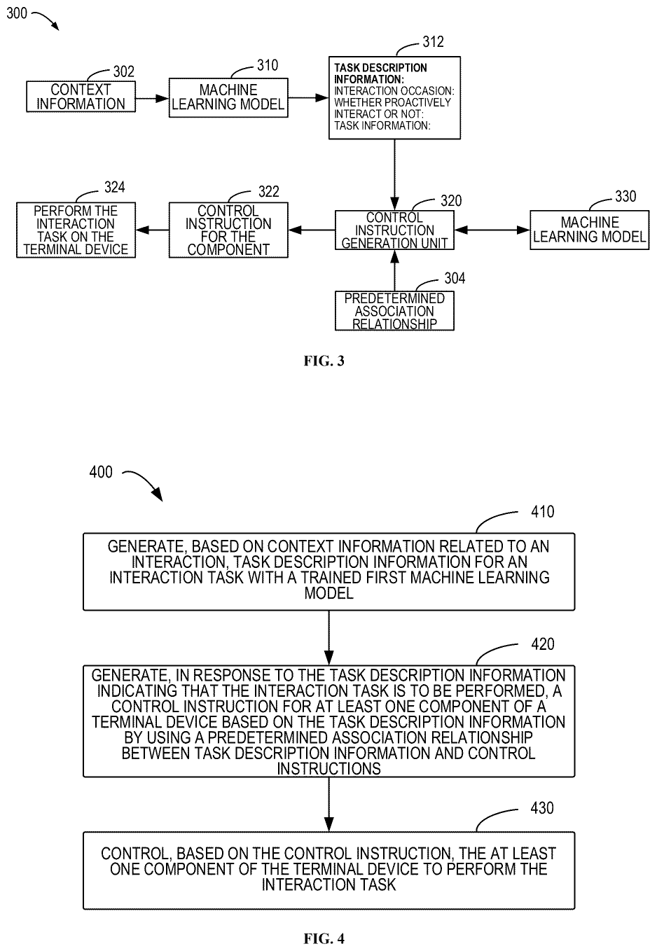

FIG. 3 illustrates an example architecture 300 for interaction processing according to some embodiments of the present disclosure. The example architecture 300 may be implemented at the terminal device 110. For ease of discussion, architecture 300 will be described with reference to environment 100 of FIG. 1. It should be noted that operations performed by the forgoing terminal device 110 and operations performed by the terminal device 110 described subsequently may be specifically performed by a related application program (for example, the application 112) installed on the terminal device 110. In some embodiments, operations performed on the terminal device 110 may be completed with the assistance of a server 120. The example architecture 300 relates to a machine learning model 310 and a control instruction generation unit 320.

In some embodiments, the terminal device 110 may obtain the context information 302 related to the interaction in any suitable manner. The interaction may be, for example, an interaction between a user and a digital assistant. In some embodiments, the terminal device 110 may capture environmental information via one or more sensors associated with itself and determine the environmental information as at least a part of context information 302. The sensors associated with the terminal device 110 may include sensors (including, but are not limited to, an accelerometer, a gyroscope, a camera, an ambient light sensor, a microphone, a locator (for example, a GPS), and the like) installed in the terminal device 110.

In some embodiments, the terminal device 110 may further obtain historical interaction information of the user, and determine the historical interaction information as at least a part of the context information 302. As an example, for interaction between the user and the digital assistant, the context information 302 may include historical interaction information of the user and the digital assistant, and the historical interaction information may include historical questions from the user, historical reply from the digital assistant, and the like.

In some embodiments, the terminal device 110 may further obtain device status information (for example, memory usage rate, processing system usage rate, etc.) of the terminal device 110 itself, current time information, and the like. If an interaction is a question and answer interaction between the user and the digital assistant, the terminal device 110 may further obtain session information (for example, a session ID) corresponding to the question and answer. The terminal device 110 may also determine the information as a part of the context information 302. It should be understood that the context information 302 may include any suitable information, which is not limited in the present disclosure.

In some embodiments, the terminal device 110 may directly determine obtained information as the context information 302. For example, the terminal device 110 may directly determine the environment information and the historical interaction information as obtained context information 302. In some embodiments, the terminal device 110 may further process obtained information by means of another trained machine learning model, and determine a processing result as context information 302. The machine learning model may summarize and generalize a large amount of context information 302. For example, the machine learning model may determine indicator values respectively corresponding to a plurality of indicators from a large amount of context information based on the plurality of predetermined indicators. As an example, the plurality of indicators may include a degree of importance, a degree of urgency, a degree of relevance to current interaction, a degree of information processing complexity, a frequency of use of the digital assistant by the user, and the like. For example, if the historical interaction information indicates multiple interactions between the user and the digital assistant in the past, it may be determined that the user has a higher frequency of use of the digital assistant. The terminal device 110 may further determine a plurality of indicators output by the machine learning model and the corresponding plurality of indicator values as the context information 302.

The terminal device 110 may provide the context information 302 to the machine learning model 310. The machine learning model 310 may be a machine learning model (for example, any machine learning model in the machine learning model 114) locally at the terminal device 110, or may be a machine learning model (for example, any machine learning model in the machine learning model 130 at the server-end device 120) at other devices. As an example, the machine learning model 310 may be a multimodal large language model (MLM).

If the machine learning model 310 is a machine learning model locally at the terminal device 110, the terminal device 110 may directly determine a model input for the machine learning model 310 based on the context information 302, and determine a corresponding model output by providing the model input to the machine learning model 310. If the machine learning model 310 is a machine learning model at other devices (such as the server-end device 120). In some embodiments, the terminal device 110 may directly and locally determine a model input for the machine learning model 310 based on context information 302, and send the model input 210 to the server-end device 120. In some other embodiments, the terminal device 110 may also directly provide context information 302 to the server-end device 120, and the server-end device 120 may determine a model input based on the context information 302 by itself in response to receiving the context information 302.

The server-end device 120 may provide a model input to the machine learning model 310 and obtain a corresponding model output from the machine learning model 310. The server-end device 120 may send the model output to the terminal device 110, so that the terminal device 110 obtains the model output for the context information 302. A model input for the machine learning model 310 may be, for example, a prompt input (prompt). In some embodiments, the prompt input for the machine learning model 310 may be determined by populating the context information 302 to a prompt template.

The model output may indicate task description information 312 for an interaction task. That is, an input of the machine learning model 310 is context information 302, and an output of the machine learning model 302 is task description information 312. The task description information 312 at least indicates whether the interaction task is to be performed. In some embodiments, the interaction task may be, for example, an active interaction task. In the case where task description information 312 indicates that an active interaction task is to be performed, operations of some components of the terminal device may be actively triggered to perform the corresponding interaction operation. The active interaction task does not need the user to actively initiate the interaction request. On the other hand, the active interaction task may implement reasonable invoke presentation by using capabilities of some components of the terminal device itself, thereby providing more and richer interaction forms, and being capable of avoiding interference to the user while transferring information. In some embodiments, if task description information 312 indicates that an interaction task is to be performed, the task description information 312 may further indicate an execution occasion of the interaction task and task information of the interaction task.

Task description information 312 may be any suitable form of information. In some embodiments, task description information 312 includes information represented in a form of a natural language. For example, task description information may be natural language text that is easy for the user to understand.

In task description information, for a field of whether an interaction task is to be performed, a value of the field may include “yes” and “no”. If the value for executing the interaction task is “yes”, the task description information indicates that the interaction task is to be executed, and the corresponding control instruction is to be executed by the components in the terminal device. If the value for executing the interaction task is “no”, the task description information indicates that the interaction task does not need to be performed, and the corresponding control instruction is not executed by the components in the terminal device.

An execution occasion of an interaction task may indicate when an interaction task is performed, and its possible value may be defined as “any”, “instant”, or any specific time point. For example, if the value of the execution occasion is “any”, the task description information indicates that the interaction task may be performed at any appropriate moment. If the value of the execution occasion is “instant”, the task description information indicates that the interaction task needs to be performed immediately. If the value of the execution occasion is a specific time point (for example, moment A), the task description information indicates that the interaction task needs to be performed immediately at the moment A.

Task information of an interaction task is a specific interaction form of information in a certain modality, that is, a visual style or auditory style of the information. For example, in a visual modality, an interaction form may be a chart, an animation, a text, or a light effect; in an auditory modality, the interaction form may be voice, music, a prompt tone, or the like. The task information may simply and conveniently describe, in a brief language, what task is to be performed, how a task to be performed, and some parameters required to perform a task. It should be noted that the task information does not need to describe specific details of the execution of the task in detail. The task information is an abstract description of what task is performed.

Referring to Table 1, Table 1 shows some examples of task description information 312:

TABLE 1

| | |
|---|---|
| Task description | Interaction occasion: Any |
| information A | Whether proactively interact or not: Yes |
| | Task information: Provide a soft visual |
| | prompt through the low-frequency signal |
| | channel of the terminal device. This not |
| | only avoids forcibly interrupting the user's |
| | workflow but also does not significantly |
| | distract the user's attention. |
| Task description | Interaction occasion: Instant |
| information B | Whether proactively interact or not: Yes |
| | Task information: Convey urgent traffic |
| | information through voice prompt of the |
| | terminal device to ensure driving safety. |

In Table 1, the task description information A may indicate that the interaction task may be proactively performed at any time. The task information of the interaction task includes a description of the interaction task (for example, the text “provide a soft visual prompt through the low-frequency signal channel of the terminal device. This not only avoids forcibly interrupting the user's workflow but also does not significantly distract the user's attention”). The task description information B may indicate that the proactive interaction task may be performed immediately. The task information of the interaction task includes a description of the interaction task (for example, the text “convey urgent traffic information through voice prompt of the terminal device to ensure driving safety”).

The task description information 312 generated by the machine learning model 310 is provided to the control instruction generation unit 320. The control instruction generation unit 320 may generate, in response to the task description information indicating that the interaction task is to be performed, a control instruction 322 for at least one component of a terminal device 110 based on the task description information 312 by using a predetermined association relationship 304 between task description information and control instructions. The association relationship 304 may indicate which task description information corresponds to which control instructions. The at least one component includes various types of hardware components, software components related to the interaction. The at least one component is a component deployed at the terminal device 110 and/or a component that can be invoked by the terminal device 110.

The control instruction generation unit 320 may generate the control instructions in any suitable manner. In some embodiments, the control instruction generation unit 320 may predetermine some control instruction determination strategies or algorithms. The control instruction generation unit 320 may generate the control instruction 322 from the task description information 312 based on predetermined strategies or algorithms. In some embodiments, the control instruction generation unit 320 may further generate a control instruction 322 for an interaction task based on task description information 312 with a trained machine learning model 330. The machine learning model 330 is trained to be capable of indicating the association relationship 304. That is, an input of the machine learning model 330 is the task description information 312, and an output of the machine learning model 330 is the control instruction 322.

The model size of the machine learning model 330 may be smaller than the model size of the machine learning model 310. In some embodiments, the machine learning model 330 may be deployed locally at the terminal device 110. The model size of each machine learning model is associated with a parameter scale, model structure complexity, etc. of the machine learning model. Generally, the larger the parameter scale or the more complex the structure of the machine learning model, the larger the model size of the machine learning model. The larger the model size of a machine learning model, the greater the resource overhead it requires. Resource overheads include, but are not limited to, computing resources, memory resources, time consumption, and the like. In summary, the task description information 312 may be determined by means of a machine learning model 310 with a larger size, and the control instruction 322 may be determined by means of a machine learning model 330 with a smaller size.

In the case where the interaction task is to be performed, the control instruction 322 for the specific component of the terminal device may indicate at least one of a presentation modality or an interaction mode of the component. The presentation modality refers to the sensory channel through which information is presented. That is, information such as an image, a sound, tactile feedback, and the like is conveyed in different sensory output manners such as visual, auditory, and tactile. The interaction mode may indicate a mode in which the corresponding component performs the interaction, including control of interaction parameters, and so forth. Referring to Table 2, Table 2 illustrates some examples of control instructions 322:

TABLE 2

| | |
|---|---|
| Control | LED indicating light: low brightness, slow flashing. |
| instruction A | Screen: Display soft light effects on the edge of |
| | the screen at extremely low brightness. Adopt a |
| | faint breathing light effect to slowly change the |
| | brightness of the screen edge. |
| Control | LED indicating light: high brightness, fast flashing. |
| instruction B | Screen: Display warning light effects on the edge |
| | of the screen at high brightness. Adopt a fast- |
| | flashing breathing light effect. |

The control instruction A in Table 2 may be a control instruction generated based on the task description information A in Table 1, and the control instruction B may be a control instruction generated based on the task description information B in Table 1. The control instruction A and the control instruction B may indicate that the presentation modality of the LED light and the screen is a visual modality, and may indicate their respective interaction modes. For example, the control instruction A may indicate the LED light to perform the interaction with low brightness, slow flashing.

In some embodiments, the control instruction may further include a specific control parameter of the component. Referring to Table 3, Table 3 illustrates another example of a control instruction 322:

```
TABLE 3
Description: “screen displays soft light effects on the edge of the screen at
extremely low brightness”,
“brightness”: {
  [Initial]: 0.1 ,
  [Maximum]: 0.3 ,
  [Minimum value]: 0.05 ,
  “Transition effect”: “Breathing”,
  “Transition speed”: “slow”
}
```

As shown in Table 3, in some embodiments, the control instruction may instruct the screen to display soft light effects on the edge of the screen at extremely low brightness, and may indicate that the initial value of the brightness of the screen is 0.1, the maximum value is 0.3, the minimum value is 0.05, and the brightness transitions with a breathing light effect at a low speed.

The terminal device 110 may obtain the control instruction 322 and control the at least one component of the terminal device 110 to perform (314) the interaction task based on the control instruction 232. For example, if the terminal device 110 obtains the control instruction A in the table 2, the LED light may be controlled to perform interaction with low brightness and slow flashing, and the screen is controlled to display soft light effects on the edge of the screen at extremely low brightness. With a weak breathing light effect, the brightness of the edge of the screen is slowly changed.

The application of the machine learning model 310 and the machine learning model 330 is described above. The training manners of the machine learning model 310 and the machine learning model 330 are described below. It may be understood that both the machine learning model 310 and the machine learning model 330 may be trained at any suitable electronic device. Both of them may be trained at the same electronic device, or may be trained at different electronic devices. The following is an example description only by taking the training of both machine learning model 310 and machine learning model 330 at the terminal device 110 as an example.

In some embodiments, the terminal device 110 may train the machine learning model 310 with a training dataset (which may be referred to as a first training dataset) including context information and sample task description information for the sample task. Referring to Table 4, Table 4 illustrates some examples of context information and sample task description information for sample tasks:

TABLE 4

| Context information | Sample task |
|---|---|
| for sample tasks | description information |
| User behavior state: Sitting | Interaction occasion: Any |
| Interaction place: Public | Whether proactively interact or not: Yes |
| Current task: Work | Task information: Provide a soft visual |
| Interaction degree: None | prompt through the low-frequency signal |
| Importance degree: Important | channel of the terminal device. This not |
| Urgency degree: Urgent | only avoids forcibly interrupting the |
| Complexity of receiving and | user's workflow but also does not |
| processing information: Medium-High | significantly distract the user's attention. |
| Frequency of using digital | |
| assistants: Medium | |
| User behavior state: Sitting | Interaction occasion: Any |
| Interaction place: Private | Whether proactively interact or not: Yes |
| Current task: Leisure | Task information: Present in the form of |
| Interaction degree: Low | a gentle notification through the terminal |
| Importance degree: Unimportant | device without interrupting the reading |
| Urgency degree: Non-urgent | experience. |
| Complexity of receiving and | |
| processing information: Low | |
| Frequency of using digital | |
| assistants: High | |
| User behavior state: Sitting | Interaction occasion: Instant |
| Interaction place: Semi-public | Whether proactively interact or not: Yes |
| Current task: Drive | Task information: Convey urgent traffic |
| Interaction degree: Low | information through voice prompt of the |
| Importance degree: Important | terminal device to ensure driving safety. |
| Urgency degree: Urgent | |
| Complexity of receiving and | |
| processing information: Medium | |
| Frequency of using digital | |
| assistants: Low | |

The training objective for the machine learning model 310 is to enable the machine learning model 310 to output semantically coherent and correct task description information based on the obtained context information. In some embodiments, the machine learning model 310 may be a pre-trained machine learning model. The terminal device 110 may fine-tune the pre-trained machine learning model 310 using only the first training data set. In some embodiments, the machine learning model 310 may be fine-tuned in any suitable manner in Migration Learning, Parameter-Efficient Fine-Tuning (PEFT), Few-Shot Learning, Multi-Task Learning, and the like. Migration learning may migrate model parameters to a new specific task by using knowledges of the machine learning model 310 pre-trained on a large amount of general data, and may be fine-tuned on new data. The method is generally suitable for tasks with relatively small data volume, and the existing knowledge base of the model can be fully utilized.

Efficient fine-tuning of parameters may, for example, employ methods such as low-rank adaptation (LoRA) or Adapter, which may fine-tune only part of the parameters and keep most of the model parameters unchanged. This approach can significantly reduce computational overhead and memory usage, well suited for use in a resource-limited environment. Few-Shot Learning may fine-tune the machine learning model 310 by using a small amount of annotation data and a prompt template, and optimize understanding capability and generation capabilities of the model, thereby still obtaining a good performance under a low resource condition.

Multi-task learning can train the model simultaneously on multiple related tasks, and enable the model to learn richer features in the target task by sharing the presentation layer. The method improves the comprehensive capability and the migration effect of the model, and the method is suitable for scenes with similarity among tasks. In the fine tuning process, the performance of the machine learning model 310 needs to be continuously monitored to prevent overfitting. At the same time, the model compression and acceleration techniques can be used to optimize the efficiency of the model. These fine tuning strategies can effectively improve the performance of the machine learning model 310 in a specific field and maintain its universality and high efficiency.

In some embodiments, the terminal device 110 may train the machine learning model 310 by using a training dataset (which may be referred to as a second training dataset) including sample task description information and sample control instructions for sample tasks. Referring to Table 2 and Table 3, if the sample task description information is task description information A, the sample control instruction is a control instruction A. The training objective for the machine learning model 330 is to enable the machine learning model 330 to output correct control instructions that can be executed by components in the terminal device 110 based on the obtained sample task description information.

In some embodiments, the terminal device 110 may update the machine learning model in response to detecting an update request for the machine learning model. For example, the terminal device 110 may determine, in response to a change in the device information of the terminal device 110, that an invoking manner or invoking content of at least one component of the terminal device 110 changes, and further determine that an update request for the machine learning model is received. For example, if the system of the terminal device 110 itself is upgraded from version A to version B, the terminal device 110 may determine that the manner in which the component A is invoked changes, and may determine that the invoking instruction for the component needs to be updated, and then may determine that the update request for the machine learning model is received.

The update request may be for the machine learning model 310 and the machine learning model 330. In this case, the terminal device 110 needs to update two machine learning models at the same time. In some embodiments, the update request may also be for the machine learning model 310 or the machine learning model 330. In this case, the terminal device 110 may update only one machine learning model based on the update request.

Since the function of the trained machine learning model 310 is to generate task description information based on the context information, the context information being usually some information of a specified type, the task description information being a natural language text, these two pieces of information are generally less affected by the terminal device 110 itself. In some embodiments, the update request may be an update request for the machine learning model 330 used to generate control instructions. That is, the terminal device 110 updates, in response to detecting an update request for the machine learning model 330, the machine learning model 330 without updating the machine learning model 310.

As mentioned previously, the model size of the machine learning model 310 is generally greater than the model size of the machine learning model 330. Therefore, the complexity of the training of the machine learning model 310 is generally higher than the complexity of the training of the machine learning model 330. The machine learning model 330 can be trained conveniently and quickly. Updating only the machine learning model 330 may improve the efficiency of model training and/or model updating. In addition, outputting the task description information of the universal language by means of the machine learning model 310, and then generating the control instruction by means of the machine learning model 330 that facilitates iteration and updates, can ensure the adaptability of the control instruction to the terminal device.

In summary, according to various embodiments of the present disclosure, control instructions for a specific device or component do not need to be directly generated by means of the machine learning model directly, but the generation of control instructions is realized through a two-stage generation solution. In the first stage, task description information is generated with a machine learning model. The task description information describes what task to perform. In the second stage, the task description information is mapped to the control instruction on the specific terminal device based on a predetermined strategy or another machine learning model. As such, for a machine learning model that relies on context information to determine an interaction task, the model need not be updated frequently, while a lighter policy or a model used in the second stage may be flexibly updated as needed to ensure flexibility and adaptability of the generated control instructions.

FIG. 4 shows a flowchart of a method 400 for interaction processing according to some embodiments of the present disclosure. The method 400 may be implemented at the terminal device 110.

At block 410, the terminal device 110 generates, based on context information related to an interaction, task description information for an interaction task with a trained first machine learning model, the task description information at least indicating whether the interaction task is to be performed.

At block 420, the terminal device 110 generates, in response to the task description information indicating that the interaction task is to be performed, a control instruction for at least one component of a terminal device based on the task description information by using a predetermined association relationship between task description information and control instructions.

At block 430, the terminal device 110 controls, based on the control instruction, the at least one component of the terminal device to perform the interaction task.

In some embodiments, the task description information further indicates an execution occasion of the interaction task and task information of the interaction task, in response to the task description information indicating that the interaction task is to be performed.

In some embodiments, generating the control instruction for the at least one component of the terminal device includes: generating, based on the task description information, the control instruction for the at least one component of the terminal device with a trained second machine learning model, the second machine learning model being trained to be capable of indicating the association relationship.

In some embodiments, the method 400 is implemented at the terminal device, and where the second machine learning model is deployed locally at the terminal device.

In some embodiments, the method 400 further includes: updating, in response to detecting an update request for the second machine learning model, the second machine learning model without updating the first machine learning model.

In some embodiments, the second machine learning model is trained with a second training dataset, the second training dataset including sample task description information and a sample control instruction for a sample task.

In some embodiments, the context information includes at least one of the following: environment information collected by a sensor associated with the terminal device, or historical interaction information with a user.

In some embodiments, the task description information includes information represented in a form of a natural language; and/or where the control instruction indicates at least one of a presentation modality or an interaction mode of the at least one component.

In some embodiments, the first machine learning model is trained with a first training dataset, the first training dataset including context information and sample task description information for a sample task.

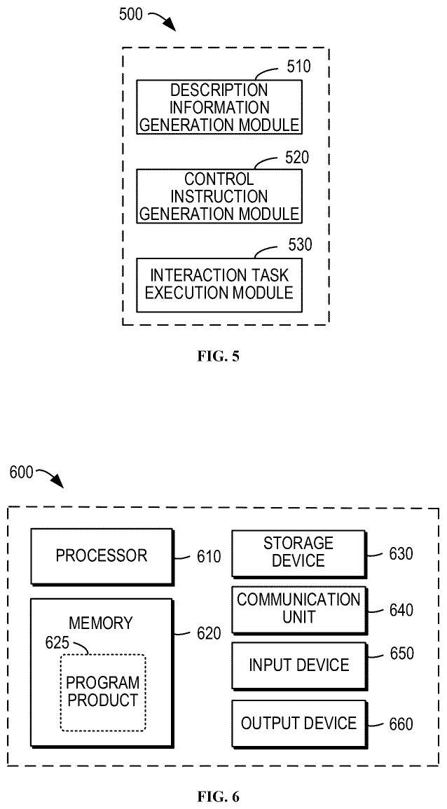

Embodiments of the present disclosure also provide a corresponding apparatus for implementing the above method or process. FIG. 5 illustrates an example structural block diagram of an apparatus 500 for interaction processing according to some embodiments of the present disclosure. The apparatus 500 may be implemented as the terminal device 110 or included in the terminal device 110. The various modules/components in the apparatus 500 may be implemented by hardware, software, firmware, or any combination thereof.

As shown in FIG. 5, the apparatus 500 includes a description information generation module 510 configured to generate, based on context information related to an interaction, task description information for an interaction task with a trained first machine learning model, the task description information at least indicating whether the interaction task is to be performed. The apparatus 500 further includes a control instruction generation module 520 configured to generate, in response to the task description information indicating that the interaction task is to be performed, a control instruction for at least one component of a terminal device based on the task description information by using a predetermined association relationship between task description information and control instructions. The apparatus 500 further includes an interaction task execution module 530 configured to control, based on the control instruction, the at least one component of the terminal device to perform the interaction task.

In some embodiments, the task description information further indicates an execution occasion of the interaction task and task information of the interaction task, in response to the task description information indicating that the interaction task is to be performed.

In some embodiments, the control instruction generation module 520 is further configured to: generate, based on the task description information, the control instruction for the at least one component of the terminal device with a trained second machine learning model, the second machine learning model being trained to be capable of indicating the association relationship.

In some embodiments, the apparatus 500 is implemented at the terminal device, and where the second machine learning model is deployed locally at the terminal device.

In some embodiments, the apparatus 500 further includes: an updating module, configured to: update, in response to detecting an update request for the second machine learning model, the second machine learning model without updating the first machine learning model.

In some embodiments, the second machine learning model is trained with a second training dataset, the second training dataset including sample task description information and a sample control instruction for a sample task.

In some embodiments, the context information includes at least one of the following: environment information collected by a sensor associated with the terminal device, or historical interaction information with a user.

In some embodiments, the task description information includes information represented in a form of a natural language; and/or where the control instruction indicates at least one of a presentation modality or an interaction mode of the at least one component.

In some embodiments, the first machine learning model is trained with a first training dataset, the first training dataset including context information and sample task description information for a sample task.

The modules included in the apparatus 500 may be implemented in various manners, including software, hardware, firmware, or any combination thereof. In some embodiments, one or more modules may be implemented using software and/or firmware, such as machine-executable instructions stored on a storage medium. In addition to or as an alternative to machine-executable instructions, some or all of the modules in the apparatus 500 may be implemented, at least in part, by one or more hardware logic components. By way of example and not limitation, example types of hardware logic components that may be used include field programmable gate arrays (FPGAs), application specific integrated circuits (ASICs), application-specific standard product (ASSPs), system-on-chips (SOCs), complex programmable logic devices (CPLDs), and the like.

It should be understood that one or more steps of the above methods may be performed by a suitable electronic device or a combination of electronic devices. Such an electronic device or a combination of electronic devices may include, for example, the terminal device 110 in FIG. 1.

FIG. 6 illustrates a block diagram of an electronic device 600 in which one or more embodiments of the present disclosure may be implemented. It should be understood that the electronic device 600 illustrated in FIG. 6 is merely illustrative and should not constitute any limitation on the functionality and scope of the embodiments described herein. The electronic device 600 shown in FIG. 6 may be configured to implement the terminal device 110 in FIG. 1 or the apparatus 500 in FIG. 5.

As shown in FIG. 6, the electronic device 600 is in the form of a general-purpose electronic device. Components of the electronic device 600 may include, but are not limited to, one or more processing units or processors 610, a memory 620, a storage device 630, one or more communication units 640, one or more input devices 650, and one or more output devices 660. The processor 610 may be an actual or virtual processor and capable of performing various processes according to programs stored in the memory 620. In multiprocessor systems, multiple processors execute computer-executable instructions in parallel to improve parallel processing capabilities of electronic device 600.

The electronic device 600 typically includes a plurality of computer storage media. Such media may be any available media accessible by the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communications unit 640 implements communications with other electronic devices over a communications medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 6+00 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer-readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

1. A method for interaction processing, comprising:
generating, based on context information related to an interaction, task description information for an interaction task with a trained first machine learning model, the task description information at least indicating whether the interaction task is to be performed;
generating, in response to the task description information indicating that the interaction task is to be performed, a control instruction for at least one component of a terminal device based on the task description information by using a predetermined association relationship between task description information and control instructions; and
controlling, based on the control instruction, the at least one component of the terminal device to perform the interaction task.

2. The method of claim 1, wherein the task description information further indicates an execution occasion of the interaction task and task information of the interaction task, in response to the task description information indicating that the interaction task is to be performed.

3. The method of claim 1, wherein generating the control instruction for the at least one component of the terminal device comprises:
generating, based on the task description information, the control instruction for the at least one component of the terminal device with a trained second machine learning model, the second machine learning model being trained to be capable of indicating the association relationship.

4. The method of claim 3, wherein the method is implemented at the terminal device, and wherein the second machine learning model is deployed locally at the terminal device.

5. The method of claim 3, further comprising:
updating, in response to detecting an update request for the second machine learning model, the second machine learning model without updating the first machine learning model.

6. The method of claim 3, wherein the second machine learning model is trained with a second training dataset, the second training dataset comprising sample task description information and a sample control instruction for a sample task.

7. The method of claim 1, wherein the context information comprises at least one of the following: environment information collected by a sensor associated with the terminal device, or historical interaction information with a user.

8. The method of claim 1, wherein the task description information comprises information represented in a form of a natural language; and/or
wherein the control instruction indicates at least one of a presentation modality or an interaction mode of the at least one component.

9. The method of claim 1, wherein the first machine learning model is trained with a first training dataset, the first training dataset comprising context information and sample task description information for a sample task.

10. An electronic device, comprising:
at least one processor; and
at least one memory coupled to the at least one processor and storing instructions for execution by the at least one processor, the instructions, when executed by the at least one processor, causing the electronic device to perform acts comprising:
generating, based on context information related to an interaction, task description information for an interaction task with a trained first machine learning model, the task description information at least indicating whether the interaction task is to be performed;
generating, in response to the task description information indicating that the interaction task is to be performed, a control instruction for at least one component of a terminal device based on the task description information by using a predetermined association relationship between task description information and control instructions; and
controlling, based on the control instruction, the at least one component of the terminal device to perform the interaction task.

11. The electronic device of claim 10, wherein the task description information further indicates an execution occasion of the interaction task and task information of the interaction task, in response to the task description information indicating that the interaction task is to be performed.

12. The electronic device of claim 10, wherein generating the control instruction for the at least one component of the terminal device comprises:
generating, based on the task description information, the control instruction for the at least one component of the terminal device with a trained second machine learning model, the second machine learning model being trained to be capable of indicating the association relationship.

13. The electronic device of claim 12, wherein the acts are implemented at the terminal device, and wherein the second machine learning model is deployed locally at the terminal device.

14. The electronic device of claim 12, wherein the acts further comprise:
updating, in response to detecting an update request for the second machine learning model, the second machine learning model without updating the first machine learning model.

15. The electronic device of claim 12, wherein the second machine learning model is trained with a second training dataset, the second training dataset comprising sample task description information and a sample control instruction for a sample task.

16. The electronic device of claim 10, wherein the context information comprises at least one of the following: environment information collected by a sensor associated with the terminal device, or historical interaction information with a user.

17. The electronic device of claim 10, wherein the task description information comprises information represented in a form of a natural language; and/or
wherein the control instruction indicates at least one of a presentation modality or an interaction mode of the at least one component.

18. The electronic device of claim 10, wherein the first machine learning model is trained with a first training dataset, the first training dataset comprising context information and sample task description information for a sample task.

19. A non-transitory computer-readable storage medium having a computer program stored thereon, the computer program being executable by a processor to implement acts comprising:
generating, based on context information related to an interaction, task description information for an interaction task with a trained first machine learning model, the task description information at least indicating whether the interaction task is to be performed;
generating, in response to the task description information indicating that the interaction task is to be performed, a control instruction for at least one component of a terminal device based on the task description information by using a predetermined association relationship between task description information and control instructions; and
controlling, based on the control instruction, the at least one component of the terminal device to perform the interaction task.

20. The non-transitory computer-readable storage medium of claim 19, wherein the task description information further indicates an execution occasion of the interaction task and task information of the interaction task, in response to the task description information indicating that the interaction task is to be performed.
